(19) United States
(12) Patent Application Publication
(10) Pub. No.: US 2006/0283899 A1
(43) Pub. Date: Dec. 21, 2006

(54) SEATBACK STORAGE DEVICE

(76) Inventor: Daniel Craig Hill, Atlanta, GA (US)

Correspondence Address: GRAY, PLANT, MOOTY, MOOTY & BENNETT, P.A., P.O. BOX 2906, MINNEAPOLIS, MN, 55402-0906, US

(21) Appl. No.: 11/381,299

(22) Filed: May 2, 2006

Related U.S. Application Data
(60) Provisional application No. 60/676,517, filed on May 2, 2005.

(51) Int. Cl. B60R 7/00; B60R 9/00

(52) U.S. Cl. 224/275; 224/400

(57) ABSTRACT

The present invention comprises a flexible organizer unit adapted for use with a seating unit. The flexible organizer unit has a body having a top and a bottom, and a plurality of pockets disposed on a surface of the body, each pocket comprising an interior therein and an opening into the interior. At least one of the pockets includes a releasable fastener adapted for selectively defining a partition in the opening. The flexible organizer unit also includes a first retainer attached to the body and adapted to secure the body to the aircraft seating unit.

### RELATED APPLICATION

The present application claims the benefit of U.S. Provisional Application 60/676,517, filed May 2, 2005 included herein in its entirety by reference.

### FIELD OF THE INVENTION

The present invention relates generally to storage devices. More specifically, the invention relates specifically to a seatback storage organizer unit for use with the seats in a small aircraft.

### BACKGROUND OF THE INVENTION

Aviation, particularly of small aircraft, is well-enjoyed by amateur pilots flying for recreation, and many commercial pilots also fly small aircraft. While the advantages of a small aircraft are numerous, the most obvious disadvantage is the small size of the aircraft. Extra space is at a premium in small aircraft, and finding space to store necessary items for flight can be difficult.

Pilots may rely on numerous items to assist them while flying. Various charts and maps may be consulted during flight, and a pilot operating handbook, manuals, and logbooks must also be on board and stored. It is desirable to have storage space for these and other items such as oxygen masks, handheld radios, eyeglasses and sunglasses, paper, writing instruments, beverages and snacks, flashlight and batteries, cleaning supplies, tissues, rags, and so forth. As it is common to encounter turbulence while flying, it would also be desirable to secure the stored items to prevent the items from becoming loose in the cockpit.

### SUMMARY OF THE INVENTION

The present invention comprises a flexible organizer unit adapted for use with a seating unit. The flexible organizer unit has a body having a top and a bottom, and a plurality of pockets disposed on a surface of the body, each pocket comprising an interior therein and an opening into the interior. At least one of the pockets includes a releasable fastener adapted for selectively defining a partition in the opening. The flexible organizer unit also includes a first retainer attached to the body and adapted to secure the body to the aircraft seating unit.

### BRIEF DESCRIPTION OF THE DRAWINGS

The invention may be more completely understood in consideration of the following detailed description of various embodiments of the invention in connection with the accompanying drawings, in which:

FIG. 1 is a side perspective view of an embodiment of the present invention as installed on a seating unit.

FIG. 2 is a side perspective view of a further embodiment of the present invention as installed on a seating unit.

FIG. 3 is a front view of an embodiment of the present invention.

FIG. 4 is a front view of a further embodiment of the present invention.

FIG. 5 is a detail view of part of the present invention.

FIG. 6 is a side view of an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE DRAWINGS

In the following detailed description of the present invention, numerous specific details are set forth in order to provide a thorough understanding of the present invention. However, it will be obvious to one skilled in the art that the present invention may be practiced without these specific details. In other instances, well-known methods, procedures, and components have not been described in detail so as to not unnecessarily obscure aspects of the present invention.

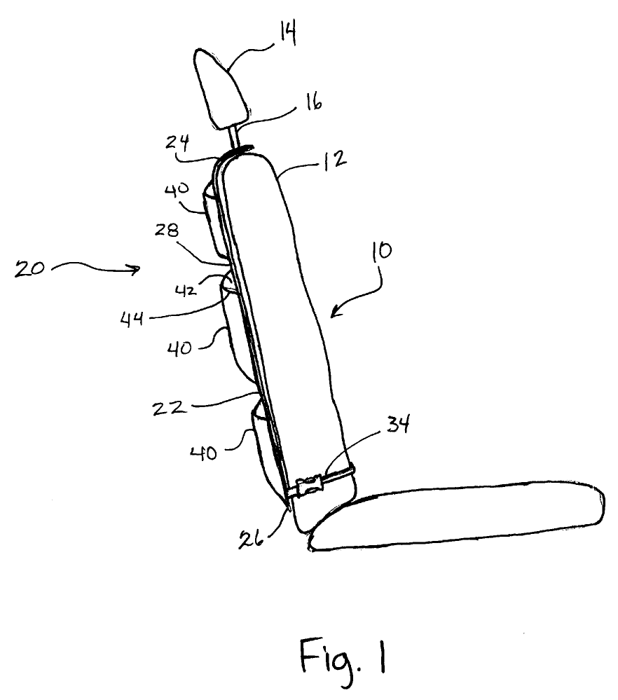

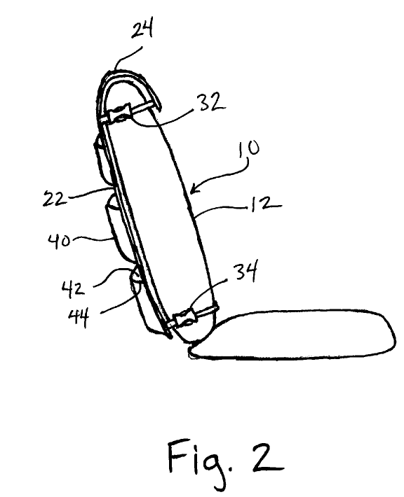

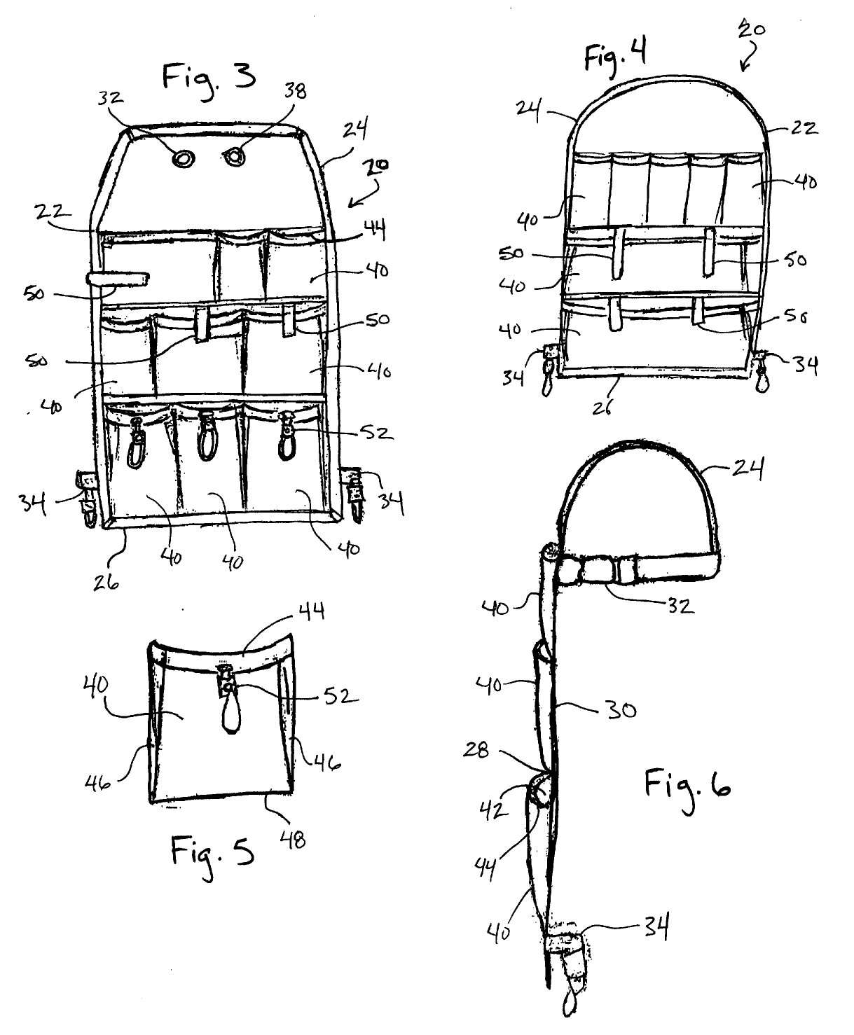

Referring now to FIGS. 1-6, an organizer 20 is provided for use with a seat 10. A typical seat 10 includes a seatback portion 12, and may or may not include a removable headrest 14 having headrest posts 16. Organizer 20 generally includes a body 22, having a top portion 24, a bottom portion 26, an outward face 28 and an inner face 30. Organizer 20 includes at least a first retention means 32 for securing to seat 10, and organizer 20 may also include a second retention means 34 and a third retention means 36.

Disposed on the outward face 28 is a plurality of pockets 40. Each pocket 40 includes one or more sides 46, a bottom 48, and an interior 42 defined therein. An opening 44 is provided into interior 42. Pockets 40 may include pleats or elastic at sides 46 and/or bottom 48 to facilitate expandability. Some pockets 40 may comprise a mesh-like material such that the contents of pocket 40 can be readily visible. One or more pockets 40 may include a fastener means 50, for example nylon polypropylene soft link webbing with hook and loop fasteners. In a preferred embodiment, fastener means 50 is secured to outward face 28 of body 22, and is releasably fastenable to a pocket 40. One or more pockets 40 may also include a closure means 52 on opening 44. For example, drawstrings comprising nylon cord pulled through grommets and releasably fastened with cord locks. Closure means 52 may also comprise a zipper, or closeable flap, or hook and loop fasteners, or snaps or buttons, or any combination thereof, or any other similar arrangement appreciated by one skilled in the art. Closure means 52 allows pocket 40 to temporarily shut such that the contents in interior 42 are secured.

Pockets 40 may be arranged in multiple rows on body 22, wherein each row includes one or more pockets 40. If a row includes only one pocket 40, providing multiple fastener means 50 allows the pocket 40 to be selectively and releasably partitioned, wherein large items are stowable in pocket 40 when fastener means 50 are released, and multiple smaller items are more easily stowed when fastener means 50 are fastened to pocket 40. Further, multiple pockets 40 may be arranged such that they partially or completely overlap, creating multiple layers of pockets 40.

In one embodiment, organizer 20 is used with a seat 10 having a headrest 14. Headrest 14 typically includes one or two headrest posts 16 that secure headrest 14 to seat 10, and also provide height adjustability. In such an embodiment, organizer 20 is configured such that top 24 of body 22 includes a first retention means 32 for engaging with headrest 14. Said first retention means 32 may comprise structure defining holes 38 for allowing headrest posts 16 to pass through top 24 of body 22, thereby securing organizer 20 to seat 10. First retention means 32 may also comprise adjustable, releasable straps for wrapping around headrest posts 16 to secure organizer 20 to seat 10.

In an alternate embodiment, organizer 20 is used with a seat 10 not having a headrest. In such an embodiment, top 24 of body 22 is configured to partially fold over the top of seat 10. A first retention means 32 is provided to secure top 24 of organizer 20 to seat 10, wherein first retention means 32 may comprise soft link webbing with side release buckles and/or tri-glide type adjustable buckles.

Bottom 26 of body 22 may include a second retention means 34 for securing the bottom of organizer 20 to seat 10. Second retention means 34 is preferably releasably and adjustably attached to seatback 12 of seat 10, and may comprise nylon polypropylene soft link webbing with grommets and nylon cord and cord locks.

A third retention means may be provided to further secure organizer 20 to seat 10. Third retention means may be located near top 24, bottom 26, or any other place on body 22.

Organizer 20 is preferably constructed from a durable, lightweight, and flexible material. In a preferred embodiment, organizer 20 is constructed from nylon packcloth, and trimmed around the edges with one inch nylon grosgrain ribbon. Organizer 20 may be installed on the front side of seatback 12, or on the backside of seatback 12.

Unless specified otherwise, it should be generally understood that first retention means 32, second retention means 34, and third retention means may comprise elasticized cords, loops, straps or webs, adjustable straps having tri-glides or other similar adjustments, straps with releasable buckles, straps with hook and loop fasteners, straps with snaps or buttons, cords with cord locks, any combination thereof, or any other similar arrangement appreciated by one skilled in the art.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

1. A seatback organizer adapted for use with a seating unit, comprising:
a body having a top and a bottom;
a plurality of pockets disposed on a surface of the body, each pocket comprising an interior therein and an opening into the interior, wherein at least one of the pockets includes a releasable fastener adapted for selectively defining a partition in the opening; and
a first retainer attached to the body and adapted to secure the body to the aircraft seating unit.

2. The seatback organizer of claim 1, wherein the first retainer is adapted to be releasably coupled to a headrest of the seating unit.

3. The seatback organizer of claim 2, wherein the first retainer comprises structure defining passages through the top of the body, the structure adapted to receive mounting posts from the headrest.

4. The seatback organizer of claim 1, wherein the first retainer comprises an adjustable strap.

5. The seatback organizer of claim 1, wherein at least one of the pockets includes a releasable closure capable of substantially closing the opening into the interior.

6. The seatback organizer of claim 1, wherein the plurality of pockets are arranged into multiple rows.

7. The seatback organizer of claim 1, wherein multiple pockets are layered upon one another.

8. The seatback organizer of claim 1, further comprising a second retainer attached to the body and adapted to secure the body to the seating unit.

9. The seatback organizer of claim 1, wherein the top of the body is adapted to fold over a top portion of the seating unit.

10. A method of stowing and organizing aviation-related sundries, the method comprising:
providing a seatback organizer comprising:
a body having a top and a bottom;
a plurality of pockets disposed on a surface of the body, each pocket comprising an interior therein and an opening into the interior, wherein at least one of the pockets includes a releasable fastener adapted for selectively defining a partition in the opening; and
a retention means attached to the body;
securing the seatback organizer to a seating unit in the aircraft, the retention means being adapted to secure the body to the seating unit; and
placing aviation-related sundries in one or more of the plurality of pockets.

11. The method of claim 10, further comprising closing the releasable fastener on at least one of the pockets, thereby partitioning the opening of the at least one pocket.

12. The method of claim 10, wherein at least one of the pockets includes a releasable closure capable of substantially closing the opening into the interior.

13. The method of claim 10, wherein the plurality of pockets are arranged in rows.

14. The method of claim 10, wherein the step of securing the flexible organizer unit to a seating unit in the aircraft comprises securing the flexible organizer unit to a headrest of the seating unit in the aircraft.

15. The method of claim 10, wherein the retention means comprises structure defining passages through the top of the body, the structure adapted to receive mounting posts from the headrest.

16. A method of stowing and securing objects, the method comprising:
securing an organizer to an aircraft seat, the organizer having:
a body, including a top and a bottom;
a plurality of pockets arranged on a surface of the body, each pocket comprising an interior therein and an opening into the interior wherein at least one of the pockets includes a releasable means for fastening adapted for selectively defining a partition in the opening; and
a retention means proximate the top of the body, the organizer being secured to the aircraft seat by the retention means;
locating objects into one or more of the pockets; and
releasably engaging a means for fastening on at least one of the pockets, such that the pocket is partitioned and the contents of the pocket are secured.

17. The method of claim 16, wherein the step of securing an organizer to an aircraft seat further comprises securing the organizer to a front side of the seat.

18. The method of claim 16, wherein at least one of the pockets includes a releasable closure capable of substantially closing the opening into the interior.

19. The method of claim 16, wherein the step of securing an organizer to an aircraft seat further comprises releasably coupling the organizer to a headrest of the aircraft seat.

20. The method of claim 16, wherein the retention means comprises structure defining passages through the top of the body, the structure adapted to receive mounting posts from the headrest.
